(19) United States
(12) Patent Application Publication
(10) Pub. No.: US 2005/0088543 A1
(43) Pub. Date: Apr. 28, 2005

(54) Digital camera and image generating method

(75) Inventor: Masayuki Yoshii, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA CAMERA, INC.

(21) Appl. No.: 10/800,509

(22) Filed: Mar. 15, 2004

(30) Foreign Application Priority Data
Oct. 27, 2003 (JP) JP2003-365547

(51) Int. Cl. H04N 5/262

(52) U.S. Cl. 348/239

(57) ABSTRACT

An image capturing system has a digital camera and a supporting stand which can move the digital camera in parallel with the surface of a placed original (subject). In the image capturing system, an image of a subject is captured. In the case where reflection from a room lighting device occurs in an area in a captured image, the digital camera is moved in parallel by using the supporting stand and captures an image again. Consequently, the position where the reflection occurs is changed in an image capturing range, so that the reflection does not occur in an area in a captured image of the subject corresponding to the area in which the reflection occurs. When the image part of the area where the reflection occurs is replaced with the image part of the area, an image from which the reflection is removed is obtained. As a result, reflection in an image can be easily and promptly removed.

This application is based on application No. 2003-365547 filed in Japan, the contents of which are hereby incorporated by reference.

### BACKGROUND OF THE INVENTION

1. Field of the Invention

The present invention relates to a digital camera capable of detecting an area, in which reflection occurs, in an image of a subject.

2. Description of the Background Art

In a digital camera, control of the picture quality is easy. As compared with a camera using a silver-halide film, a digital camera is more advantageous with respect to photographing adapted to environments and subjects. Consequently, a digital camera can be used not only for normal photographing but also capturing of an image of a white board used in a meeting in a company. A digital camera can be also used, as an imaging device for an overhead projector for presentation (hereinafter referred to as “an overhead camera system”), for capturing an image of an original and the like. In the photographing, however, since a subject has a flat plane or a gentle curve face, the possibility of occurrence of reflection of light into the white board or the surface of the original is high.

For example, when an image of a white board is captured in an environment with sufficient illumination, since the surface of the white board is flat and is glossy, external light and room light is easily reflected in an image. When images of the white board are captured by a camera as a record of a meeting, part of a subject often becomes white in an image due to an influence of the reflection. It is difficult to read letters written on the white board from the captured image.

For example, Japanese Patent Application Laid-Open No. 10-210353 (1998) discloses a technique wherein it is determined that, on the basis of a histogram indicating level distribution of image data, whether or not regular reflection light exists on a subject, specifically, whether or not room light or external light such as outdoor light like sun light enters an image of the subject and, when it is determined that external light is reflected in an image, without recording the image, occurrence of reflection of light is warned.

On the other hand, in an overhead camera system (image capturing system), the surface of which image is to be captured of an original (subject) faces upward, in other words, the original is placed so that its surface faces indoor light, so that reflection of the light tends to be captured in an image. In the case of capturing images of an original prior to presentation, images are captured often in an office and are influenced by external light such as room light.

In the case of using an overhead camera system during presentation, because of improvement in performance of a projector and increase in the number of presentations using presentation software in a personal computer, presentation is often made under normal room light. When an image of the subject (original) is captured in such a situation, reflection frequently occurs in an image. In the image in which reflection occurs, the quality of a display image deteriorates and an influence is exerted on the presentation.

In an overhead camera system having dedicated light, a louver for preventing reflection is provided for the dedicated light as disclosed in Japanese Patent Application Laid-Open Nos. 8-18736 (1996) and 11-174578 (1999), or reflection is prevented by changing the position of the dedicated light as disclosed in Japanese Patent Application Laid-Open No. 8-336065 (1996). In an overhead camera system having no dedicated light, for example, as disclosed in Japanese Patent Application Laid-Open No. 11-187214 (1999), a digital camera is moved in parallel with the subject and, an image of the subject is captured in a position where reflection does not occur on the subject, thereby preventing reflection.

In the digital camera disclosed in Japanese Patent Application Laid-Open No. 10-210353 (1998), when reflection occurs, only a warning is given. Consequently, when the warning is given, photographing of a subject is stopped and it becomes difficult to perform prompt image capturing.

In the overhead camera system disclosed in Japanese Patent Application Laid-Open Nos. 8-18735 (1996) and 11-174578 (1999), a louver for preventing reflection has to be provided, so that the system configuration is complicated.

In the overhead camera system disclosed in Japanese Patent Application Laid-Open Nos. 8-336065 (1996) and 11-187214 (1999), a dedicated light device and a digital camera are moved until a position where no reflection occurs is detected. Consequently, time for movement is necessary, so that it is difficult to perform prompt image capturing.

### SUMMARY OF THE INVENTION

It is therefore an object of the present invention to provide a technique of a digital camera capable of easily and promptly removing reflection.

The present invention is directed to a digital camera.

According to one aspect of the present invention, the digital camera comprises: (a) an image capturing part for capturing an image of a subject; (b) a detector for detecting a reflection area, in which reflection occurs, in the image; and (c) a processor for performing a predetermined process on a first image and a second image captured by the image capturing part while changing relative positions between the subject and the digital camera, wherein the predetermined process includes the steps of: (c-1) setting the reflection area detected by the detector in the first image as an image portion to be replaced; (c-2) extracting a replacing image portion which corresponds to a site of the subject appearing in the image portion to be replaced and is not detected as the reflection area by the detector in the second image; and (c-3) replacing the image portion to be replaced in the first image with the replacing image portion extracted in the step (c-2). Thus, reflection in an image can be easily and promptly removed.

The present invention is also directed to an image generating method.

According to another aspect of the present invention, the image generating method comprises the steps of: (a) capturing a first image and a second image of a subject while changing relative positions between a subject and a digital camera; (b) detecting a reflection area, in which reflection occurs, in the image captured in the step (a); (c) carrying out a first specifying process for setting, as an image portion to be replaced, the reflection area detected in the step (b) in the first image; (d) carrying out a second specifying process of extracting a replacing image portion which corresponds to a site of the subject appearing in the image portion to be replaced and is not detected as the reflection area in the step (b) from the second image; and (e) replacing the image portion to be replaced in the first image with the replacing image portion extracted in the step (d). Thus, reflection in an image can be easily and promptly removed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a general configuration of an image capturing system according to a first preferred embodiment of the present invention;

FIG. 2 shows an appearance configuration of a digital camera;

FIG. 3 shows an appearance configuration of the digital camera;

FIG. 4 is a block diagram showing a functional configuration of the digital camera;

FIG. 5 is a perspective view showing an appearance configuration of a supporting stand;

FIG. 6 illustrates a camera supporting part;

FIG. 7 is a sectional view for describing a stay driving mechanism;

FIG. 8 is a perspective view for describing a stay extending/contracting mechanism;

FIG. 9 is a block diagram showing a functional configuration of the supporting stand;

FIG. 10 illustrates the principle of removing reflection;

FIGS. 11A to 11D illustrate a process for removing reflection;

FIGS. 12A to 12D illustrate the process for removing reflection;

FIG. 13 is a flowchart showing operations of a reflection correction mode;

FIG. 14 illustrates selection of a program line;

FIG. 15 is a flowchart showing operations of a reflection correcting process;

FIG. 16 is a flowchart showing the operations of the reflection correcting process;

FIGS. 17A to 17E illustrate a process for removing reflection according to a second preferred embodiment of the present invention;

FIG. 18 is a flowchart showing operations of the reflection correcting process; and

FIG. 19 is a flowchart showing operations of the reflection correcting process.

### DESCRIPTION OF THE PREFERRED EMBODIMENTS

Hereinafter, preferred embodiments of the present invention will be described with reference to the drawings.

### First Preferred Embodiment

General Configuration of Image Capturing System

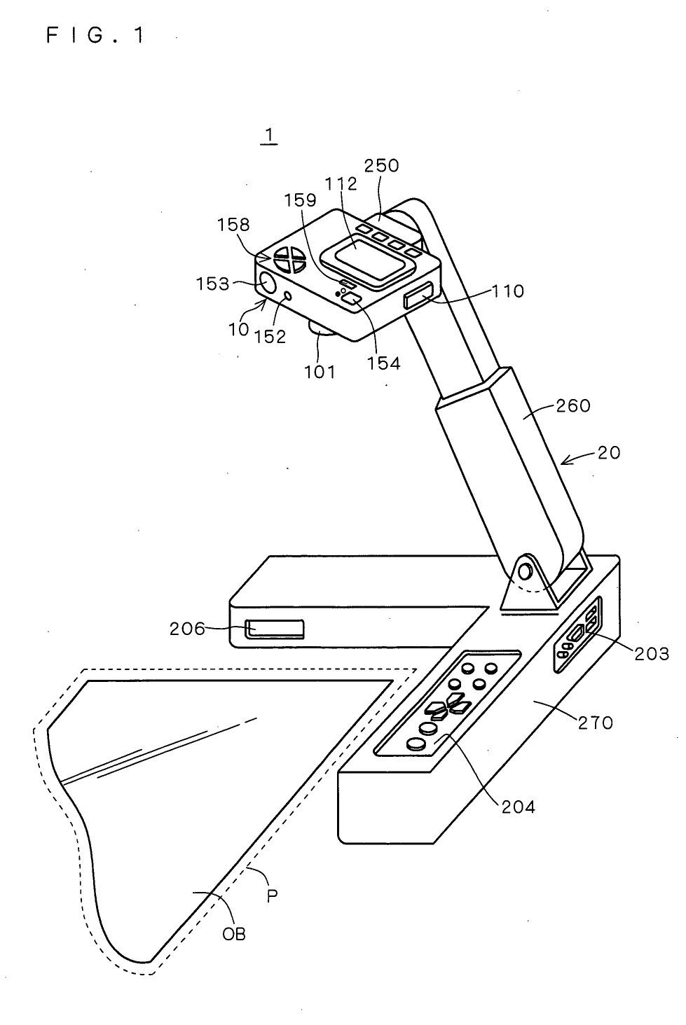

FIG. 1 shows a general configuration of an image capturing system 1 according to a first preferred embodiment of the present invention.

The image capturing system 1 is a proximity image capturing system for down-face image capturing, which captures an image of a subject such as a document or a small article placed on a subject placing space P functioning as a placing area from a relatively small distance above the subject placing space P. The image capturing system 1 is configured so as to be able to capture an image of a subject OB such as a paper original placed on the subject placing space P while maintaining a predetermined distance and to generate electronic image data. The image capturing system 1 can output the generated image data to a personal computer, a printer, a projector and the like electrically connected to an interface.

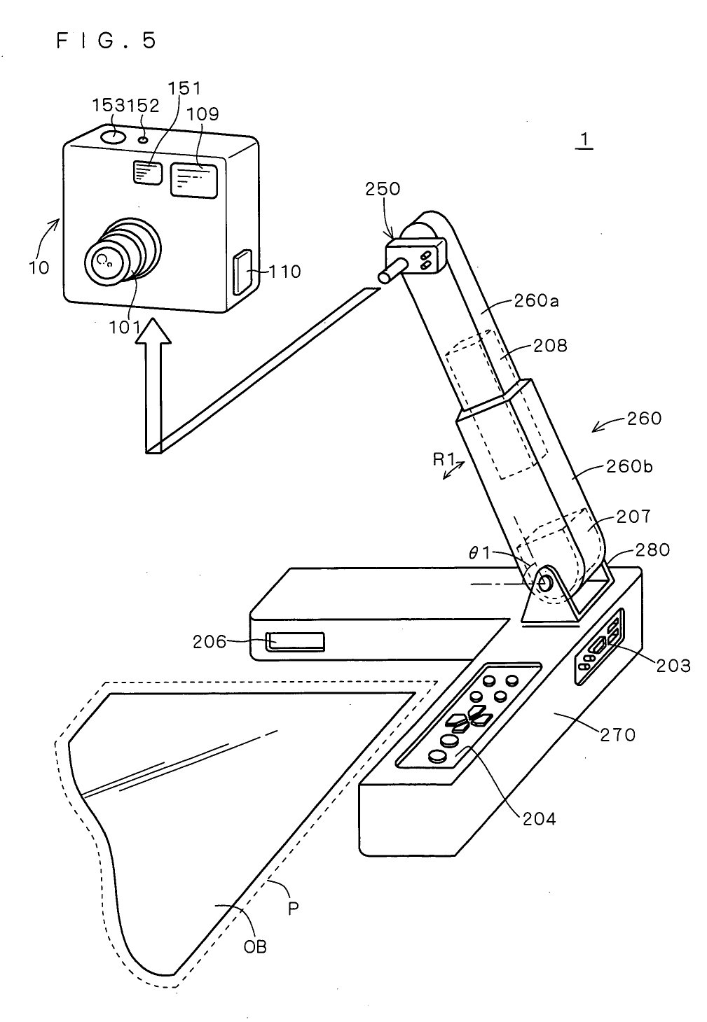

The image capturing system 1 has: a digital camera 10 functioning as an image capturing part for generating electronic image data by photoelectrically converting an image of the subject OB; and a supporting stand 20 for supporting the digital camera 10 in a position above from the subject OB only by a predetermined distance. The digital camera 10 can be separated from the supporting stand 20 as shown in FIG. 5. In this case, the digital camera 10 can be used as a normal digital camera capable of capturing an image of a subject which is positioned relatively far. The supporting stand 20 is a camera supporting stand for down-face image capturing having an earth leg extended along the periphery of the subject placing space P.

In the following, the configuration of each of the digital camera 10 and the supporting stand 20 constituting the image capturing system 1 will be described.

Configuration of Digital Camera 10

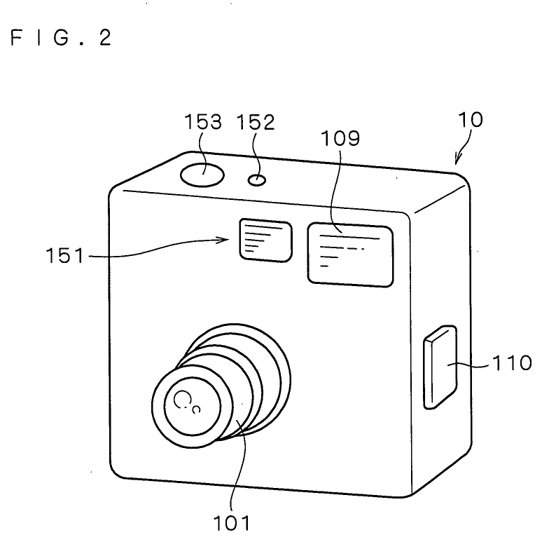

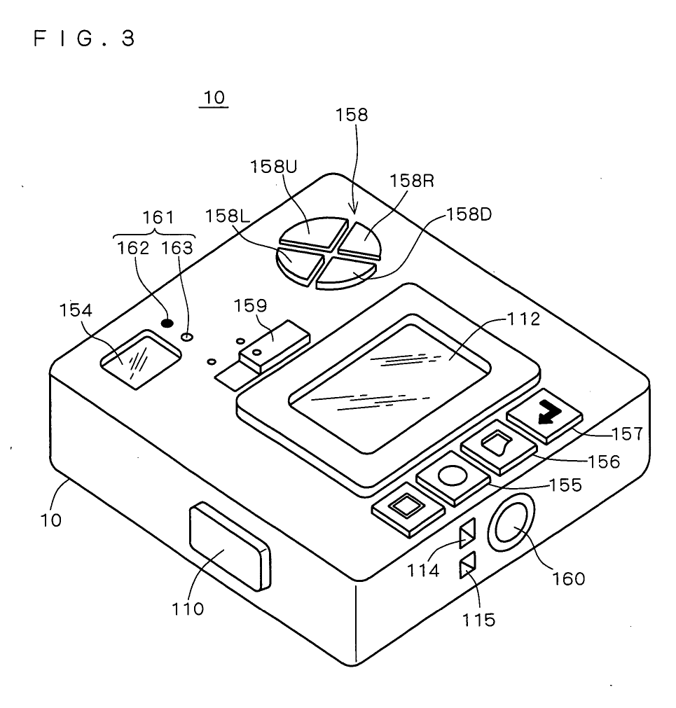

FIGS. 2 and 3 show an appearance configuration of the digital camera 10. FIG. 2 is a perspective view of the digital camera 10 seen from its front side. FIG. 3 is a perspective view of the digital camera 10 seen from its rear side.

As shown in FIG. 2, on the front face side of the digital camera 10, a taking lens 101 for getting an image of the subject is provided.

On the front face side of the digital camera 10, a built-in electronic flash 109 for emitting illumination light to the subject at the time of image capturing is also provided. The built-in electronic flash 109 is provided in the casing of the digital camera 10 and integrated with the digital camera 10.

The digital camera 10 further has an optical viewfinder. In the front face of the digital camera 10, a viewfinder objective window 151 of the optical viewfinder is provided.

On the top face side of the digital camera 10, a power switch 152 and a shutter start button 153 are provided. The power switch 152 is a switch for switching an ON state and an OFF state of the power source. Each time the power switch 152 is depressed, the ON and OFF states are sequentially switched. The shutter start button 153 is a two-level switch capable of detecting a half-depressed state (hereinafter, also referred to as an S1 state) and a fully-depressed state (hereinafter, also referred to as an S2 state). By depression of the shutter start button 153, an image of the subject can be captured.

An interface 110 is provided on a side face of the digital camera 10. The interface 110 is, for example, a USB-standard interface capable of outputting image data to an external device such as a personal computer, a printer or a projector which is electrically connected and transmitting/receiving a control signal. Because of the terminal, even in the case where the digital camera 10 is used singly separate from the supporting stand 20, the digital camera 10 can be used by being connected to an external device.

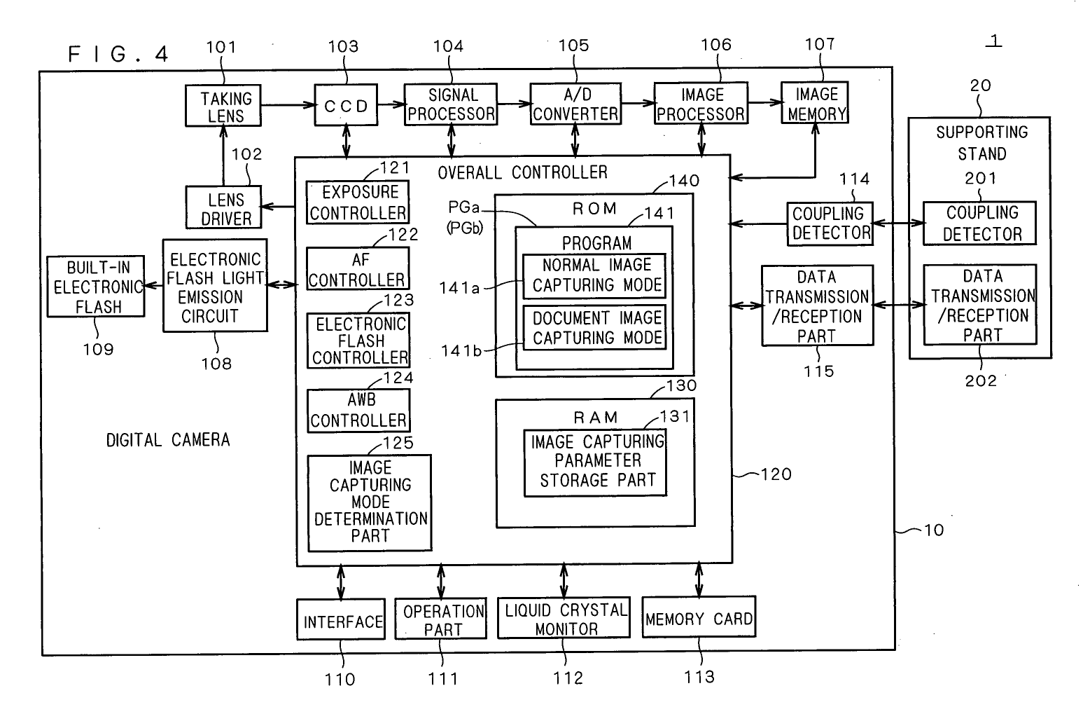

In another side face of the digital camera 10, which is not shown in FIG. 2, a card slot into which a memory card 113 (FIG. 4) as a detachable storage medium is inserted and a battery space in which a battery as a power source of the digital camera 10 is inserted are provided. The card slot and the battery space can be closed with a cover provided on the surface of the casing of the digital camera 10.

As shown in FIG. 3, on the rear side of the digital camera 10, a liquid crystal monitor 112 for displaying a captured image for monitoring and reproducing and displaying a recorded image is provided. On the rear side of the digital camera 10, a viewfinder eyepiece window 154 of the optical viewfinder is also provided. The user can photograph while recognizing the subject through the liquid crystal monitor 112 or the viewfinder eyepiece window 154.

On the rear side of the digital camera 10, an electronic flash mode button 155 is further provided. Each time the electronic flash mode button 155 is depressed, the control mode of the built-in electronic flash is cyclically switched in order as “normal image capturing mode”, “document image capturing mode” and “automatic mode”. Herein, the “normal image capturing mode” is a mode of controlling the built-in electronic flash adapted to capture of an image of a subject positioned relatively far with an electronic flash. The “document image capturing mode” is a mode of controlling the built-in electronic flash adapted to capture of an image, with an electronic flash, of a subject positioned in a predetermined position which is relatively near. The “automatic mode” is a mode of detecting a coupling state between the digital camera 10 and the supporting stage 20 by a coupling detector 114 and automatically determining, as the built-in electronic flash control mode, either the “normal image capturing mode” or the “document image capturing mode”.

On the rear side of the digital camera 10, a menu button 156 is also provided. When the menu button 156 is depressed in the image capturing mode, a menu screen for setting image capturing conditions is displayed on the liquid crystal monitor 112. With the menu screen, for example, a reflection correction mode which will be described later can be set.

On the rear side of the digital camera 10, an execution button 157 and a control button 158 constituted by cross cursor buttons 158U, 158D, 158R and 158L for moving a display cursor on the liquid crystal monitor 112 in four ways are also provided. An operation of setting various image capturing parameters is performed by using the execution button 157 and the control button 158.

On the rear side of the digital camera 10, a mode switching lever 159 for switching an operation mode of the digital camera 10 between “image capturing mode” and “reproduction mode” is also provided. The mode switching lever 159 is a slide switch of two contacts. When the mode switching lever 159 is set to the right in FIG. 3, the operation mode of the digital camera 10 is set to the “image capturing mode”. When the mode switching lever 159 is set to the left, the operation mode is set to the “reproduction mode”. When the operation mode is set to the “image capturing mode”, image data of a subject image formed on a CCD 103 (which will be described later) is continuously displayed on the liquid crystal monitor 112 while being updated at relatively high speed (so-called live-view display). By operating the shutter start button 153 to capture an image, image data of the subject can be generated. On the other hand, when the operation mode is set to the “reproduction mode”, image data recorded on the memory card 113 is read out, reproduced and displayed on the liquid crystal monitor 112. The reproduced and displayed image can be selected by the control buttons 158R and 158L.

On the rear side of the digital camera 10, a selection step indicator 161 indicative of a selection step of a base image or a follow image to be described later is also provided. The selection step indicator 161 is constituted by two LEDs 162 and 163. For example, when the LED 162 emits light, a state where a base image is selected is indicated. On the other hand, when the LED 163 emits light, a state where a follow image is selected is indicated.

On the bottom face of the digital camera 10, a coupling part 160 used for mechanical coupling to the supporting stand 20, the coupling detector 114 (FIG. 4) for detecting coupling to the supporting stand 20, and a data transmission/reception part 115 for transmitting/receiving a control signal and image data generated by the digital camera 10 are provided.

The coupling part 160 is made of a conductive metal member. In the metal member, a cylindrical hole perpendicular to the bottom face is formed and a screw groove is formed in the inner face of the cylindrical hole, thereby forming a female screw. When a male screw 251 (which will be described later) provided at a camera coupling part 250 in the supporting stand 20 is screwed in the female screw, the digital camera 10 is mechanically coupled with the supporting stand 20. Further, the metal member of the coupling part 160 is electrically connected to a reference potential point (hereinafter, referred to as GND) of an electronic circuit in the digital camera 10, and the coupling part 160 also plays the role of making GND of internal electronic circuits of the digital camera 10 and the supporting stand 20 commonly used. Alternately, the coupling part 160 may be used as a part for attaching a tripod.

The coupling detector 114 and the data transmission/reception part 115 have electrical contacts constituted so as to obtain electric conduction with signal pins (which will be described later) provided at the supporting stand 20 when the digital camera 10 and the supporting stand 20 are mechanically coupled to each other. Since the coupling part 160 allows GND to be commonly used by the digital camera 10 and the supporting stand 20, each of the coupling detector 114 and the data transmission/reception part 115 may have only one electrical contact.

The functional configuration of the digital camera 10 will now be described. FIG. 4 is a block diagram showing the functional configuration of the digital camera 10.

As shown in FIG. 4, the digital camera 10 has the taking lens 101 for forming an image of the subject. In the taking lens 101, a focusing lens can be moved so as to change a focus state of the subject. In the taking lens 101, the opening of an aperture can be adjusted so as to change an amount of incident light.

A lens driver 102 moves the focusing lens and adjusts the opening of the aperture in accordance with a control signal inputted from an overall controller 120 which will be described in detail later.

The CCD 103 is an image capturing device provided in a proper portion on the rear side of the taking lens 101 and functions for capturing an image of the subject. The CCD 103 converts the subject image formed by the taking lens 101 into image signals of color components of R (red), G (green) and B (blue) (signal trains of pixel signals outputted from pixels) and outputs the image signals.

A signal processor 104 has a CDS (Correlated Double Sampling) circuit and an AGC (Automatic Gain Control) circuit and performs a predetermined signal process on the image signal outputted from the CCD 103. Concretely, noise in the image signal is reduced by the CDS circuit and the level of the image signal is adjusted by the AGC circuit.

An A/D converter 105 converts an analog image signal outputted from the signal processor 104 into a 10-bit digital signal. Image data converted into the digital signal is outputted to an image processor 106.

The image processor 106 performs black level correction, white balance correction and γ correction on the image data inputted from the A/D converter 105. By the black level correction, the black level of image data is corrected to a predetermined reference level. By the white balance correction, the level of each of the color components of R, G and B of pixel data is converted so as to achieve a white balance in the image data subjected to γ correction. The level conversion is carried out by using a level conversion table supplied from the overall controller 120. A conversion factor of the level conversion table is set for each image capturing by the overall controller 120. By the γ correction, the tone of pixel data is corrected. The black-level corrected image data is outputted also to the overall controller 120 and is used for exposure control, auto-focus (hereinafter, abbreviated as AF) control, electronic flash control, and photometric computation and color measurement computation for setting the above-described level conversion table.

An image memory 107 is a buffer memory for temporarily storing the image data processed by the image processor 106. The image memory 107 has a storage capacity of at least one frame.

In the image capturing standby state of the image capturing mode, image data of the subject image captured every predetermined time interval by the CCD 103 is processed by the signal processor 104, A/D converter 105 and image processor 106, and the processed image data is stored in the image memory 107. The image data stored in the image memory 107 is transferred to the liquid crystal monitor 112 by the overall controller 120 and displayed so as to be visually recognized (live view display). Since the image displayed on the liquid crystal monitor 112 is updated at the predetermined time intervals, the user can visually recognize the subject by the image displayed on the liquid crystal monitor 112.

In the reproduction mode, image data read out from the memory card 113 having a nonvolatile memory connected to the overall controller 120 is subjected to a predetermined signal process in the overall controller 120, transferred to the liquid crystal monitor 112, and displayed so as to be visually recognized.

The other functional configuration of the digital camera 10 will now be described.

An electronic flash light emission circuit 108 supplies power for emitting electronic flash light to the built-in electronic flash 109 on the basis of the control signal of the overall controller 120, thereby enabling the presence/absence of light emission, a light emission timing and a light emission amount of the built-in electronic flash to be controlled.

An operation part 111 includes the electronic flash mode button 155, menu button 156, execution button 157, control button 158, power switch 152 and shutter start button 153. When the user performs predetermined operation on the operation part 111, the data indicative of the operation is transmitted to the overall controller 120 and is affected in the operation state of the digital camera 10.

The coupling detector 114 outputs a signal indicative of coupling to the overall controller 120 in the case where the digital camera 10 and the supporting stand 20 are coupled to each other. For example, the potential is set to be the GND level at the time of non-coupling and to be the power source voltage level at the time of coupling. This can be realized by a structure such that the electric contact of the coupling detector 114 is pulled down to the GND by a resistor and when the digital camera 10 and the supporting stand 20 are coupled to each other, electric conduction is brought about between the electric contact and a signal pin of the supporting stand 20 (it is constituted that the power source voltage level is set at the time of coupling).

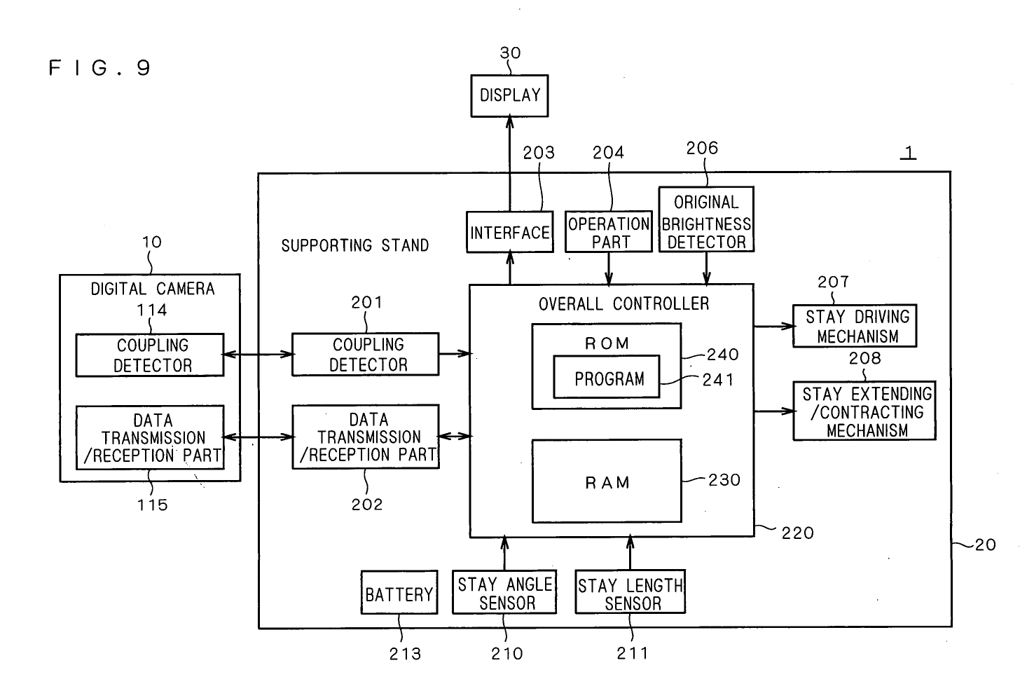

The data transmission/reception part 115 is provided to transmit/receive the control signal and image data in a predetermined communication method between the overall controller 120 of the digital camera 10 and an overall controller 220 of the supporting stand 20 in the case where the digital camera 10 and the supporting stand 20 are coupled to each other. By the data transmission/reception part 115, image data captured by the digital camera 10 can be outputted to a display 30 (FIG. 9) such as a projector via the overall controller 220 of the supporting stage 20 and the interface 203. The digital camera 10 can be also operated by an operation part 204 provided in the supporting stand 20.

The overall controller 120 is a microcomputer having a RAM 130 and a ROM 140. By carrying out a program PGa stored in the ROM 140 by the microcomputer, the overall controller 120 controls the components of the digital camera 10 in a centralized manner. The overall controller 120 also functions for performing a predetermined process on a first image and a second image captured by the CCD 103 while changing the relative position between the subject OB and the digital camera 10.

The ROM 140 of the overall controller 120 is a nonvolatile memory which cannot electrically rewrite data. The program PGa includes a subroutine corresponding to both a document image capturing mode 141a and a normal image capturing mode 141b which are described above. At the time of actual image capturing, a subroutine is used. In a part of the storage area of the RAM 130, an image capturing parameter storage part 131 is provided. In the image capturing parameter storage part 131, control parameters regarding image capturing are stored as image capturing parameters CP.

An exposure controller 121, an AF controller 122, an electronic flash controller 123, an automatic white balance (hereinafter, abbreviated as “AWB”) controller 124 and an image capturing mode determination part 125 in blocks of the overall controller 120 of FIG. 4 are schematically shown as functional blocks as part of the functions realized by the overall controller 120.

The exposure controller 121 performs an exposure control on the basis of the program PGa so that the brightness of image data becomes proper. Concretely, image data subjected to the black level correction in the signal processor 104 is obtained, brightness of the image data is calculated and, on the basis of the brightness, an aperture value and shutter speed are determined so that exposure becomes proper. Subsequently, a control signal is outputted to the lens driver 102 so that the aperture value becomes the determined aperture diameter, and the opening of the aperture of the taking lens 101 is adjusted. Further, the CCD 103 is controlled so as to accumulate charges only by exposure time corresponding to the determined shutter speed.

The AF controller 122 performs focusing control on the basis of the program PGa so that a subject image is formed on the image capturing plane of the CCD 103. Concretely, while moving the focusing lens by outputting a control signal to the lens driver 102, the AF controller 122 obtains image data subjected to the black level correction in the signal processor 104, calculates the contrast, and moves the focusing lens to a position where the contrast becomes the highest. In other words, the AF controller 122 performs the AF control of the contrast method.

The electronic flash controller 123 calculates brightness from image data regarding live view display and determines whether electronic flash light emission is necessary or not. In the case of emitting electronic flash light, electronic flash light control is performed on the basis of the program PGa so that the light emission amount of the built-in electronic flash becomes proper. Concretely, the electronic flash controller 123 outputs a control signal to the electronic flash light emission circuit 108 to perform pre-light emission with a predetermined electronic flash light emission amount (pre-light emission amount), obtains image data subjected to the black level correction in the signal processor 104, and calculates brightness. Further, the electronic flash controller 123 determines a electronic flash light emission amount at the time of image capturing operation for obtaining image data to be stored from the calculated brightness.

The AWB controller 124 performs white balance control on the basis of the program PGa so that white balance of image data becomes proper. Concretely, the AWB controller 124 obtains image data subjected to the black level correction in the signal processor 104, calculates color temperature, determines a level conversion table used for white balance correction in the image processor 106, and outputs the level conversion table to the image processor 106.

The exposure control value, AF control value, electronic flash control value and AWB control value used for image capturing can be stored as the image capturing parameters CP in the image capturing parameter storage part 131.

The image capturing mode determination part 125 determines, as a mode to be used, either the “document image capturing mode” or the “normal image capturing mode” on the basis of the electronic flash mode button 155 of the operation part 111 and a result of detection of the coupling detector 114. After determination of the image capturing mode, at the time of actual image capturing, an image is captured by using a corresponding subroutine included in the program PGa.

Configuration of Supporting Stand 20

FIG. 5 is a perspective view showing an appearance configuration of the supporting stand 20.

As shown in FIG. 5, the supporting stand 20 has the camera supporting part 250 as a part of coupling to the digital camera 10. The camera supporting part 250 is connected to an extendable stay 260 and is supported in an upper position apart from the subject placing space P only by a predetermined distance.

The stay 260 is connected so that the angle between the stay 260 and an L-shaped pedestal 270 disposed in the same plane as the subject placing space P (hereinafter, referred to as the subject placing plane) can be changed by a connection part 280.

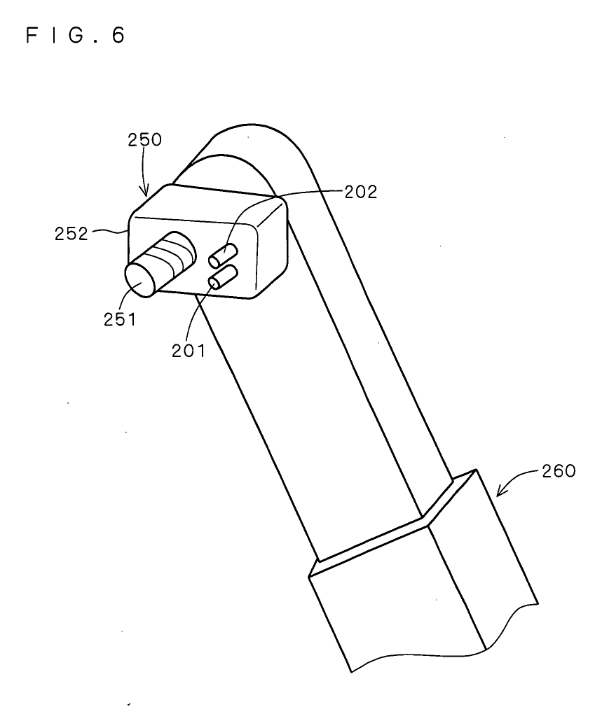

The details of the camera supporting part 250 will now be described with reference to the perspective view of FIG. 6. The camera supporting part 250 has the coupling screw 251 as a male screw which can be screwed in the female screw of the coupling part 160 of the digital camera 10. By the coupling part 160, the digital camera 10 can be detachably connected to the supporting stand 20. The coupling screw 251 is inserted into a through hole formed in a coupling part 252 and is rotatable in the coupling part 252. Consequently, by rotating a knob (not shown in FIG. 6) provided at an end opposite to the coupling end of the digital camera 10 in the coupling screw 251, the digital camera 10 and the supporting stand 20 can be coupled to each other. Further, the coupling screw 251 is made of a conductive metal material and is electrically connected to GND of the electronic circuit in the supporting stand 20. Consequently, as described above, GND of electronic circuit in the digital camera 10 and the supporting stand 20 is commonly used at the time of coupling.

The camera supporting part 250 also has a coupling detector 201 and a data transmission/reception part 202. Each of the coupling detector 201 and the data transmission/reception part 202 has a signal pin projected from a hole formed in the coupling part 252. The signal pin can be press fit by a predetermined length into the hole formed in the coupling part 252 by applying pressure. When the pressure applied is canceled, the signal pin is energized by using an elastic member such as a spring so as to be projected again by the length of press fit and to restore its original shape. The signal pins of the coupling detector 201 and the data transmission/reception part 202 are provided in positions where electric conduction with the electrical contacts of the coupling detector 114 and the data transmission/reception part 115 of the digital camera 10 can be obtained when the digital camera 10 and the supporting stand 20 are coupled to each other. With the configurations, as the coupling screw 251 of the camera supporting part 250 is screwed in the female screw of the coupling part 160 of the digital camera 10, the signal pins projected from the coupling part 252 are press-fit in the holes formed in the coupling part 252 while maintaining electric conduction with the electrical contacts of the digital camera 10. Further, when the signal pin is press-fit by a predetermined length, the coupling detector 201 outputs a signal indicating that the digital camera 10 and the supporting stand 20 are coupled to each other. For example, it is constituted so that when the signal pin is press-fit by a predetermined length, the potential of the signal pin becomes a power source level by a switch provided internally.

Next, the stay 260 will be described. The angle between the stay 260 and the subject placing plane can be changed as shown by an arrow R1 in FIG. 5. As a driving mechanism for changing the angle, a stay driving mechanism 207 is provided. The angle θ1 between the stay 260 and the subject placing plane can be detected by a stay angle sensor 210 (not shown in FIG. 5). As specifically shown in the sectional view of FIG. 7, the stay driving mechanism 207 has a motor M1 as a driving power source and a gear train GT1 having a plurality of spur gears. The gear train GT1 transmits rotational motion of a driving shaft SF1 of the motor M1 to a driven shaft SF2. The driven shaft SF2 is inserted into a through hole formed in a connection end to the pedestal 270 of the stay 260. The driven shaft SF2 is also fixed to the connection part 280. Therefore, when power is supplied to the motor M1 and a driving force is generated, the generated driving force is transmitted from the driving shaft SF1 to the driven shaft SF2, and the angle θ1 formed between the stay 260 and the subject placing plane changes. In such a manner, the angle of view of the subject OB in the document image capturing mode can be optionally adjusted.

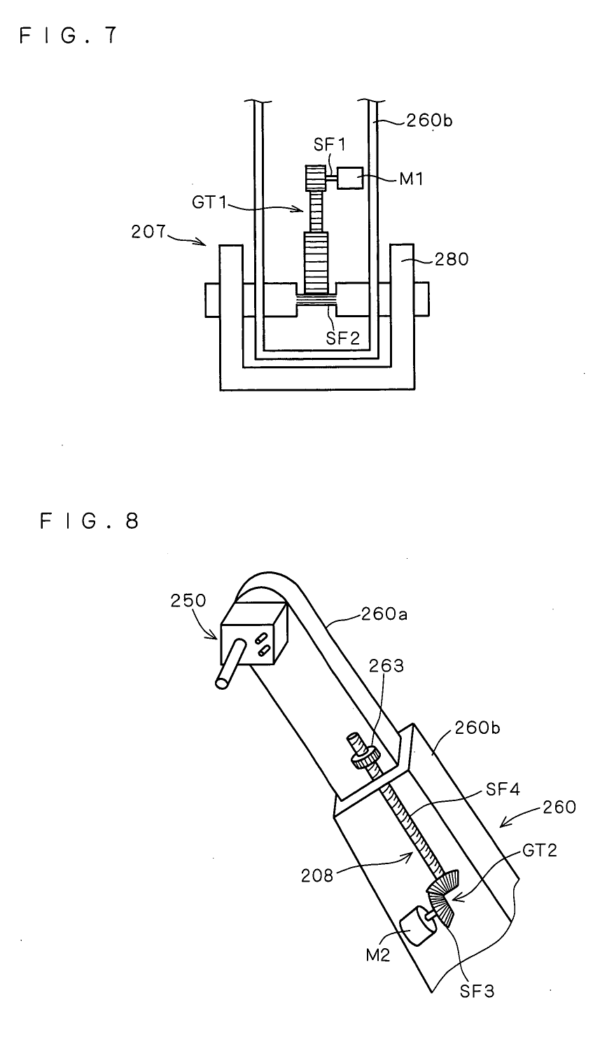

The stay 260 has a stay extending/contracting mechanism 208 for changing its length. The stay 260 is constituted by tubular members 260a and 260b having different diameters. The tubular member 260a to which the camera supporting part 250 is attached is loosely inserted into the tubular member 260b connected to the pedestal 270. The length L of the stay can be detected by a stay length sensor 211 (not shown in FIG. 5). The stay extending/contracting mechanism 208 has, as specifically shown in the perspective view of FIG. 8, a motor M2 as a driving force source and a gear train GT2 having a plurality of bevel gears. The gear train GT2 transmits rotation motion of a driving shaft SF3 of the motor M2 to a driven shaft SF4. A screw is formed on the surface of the driven shaft SF4, thereby obtaining a male screw which can be screwed in a female screw fixed to the tubular member 260a. Therefore, when power is supplied to the motor M2 and the driving force is generated, the generated driving force is transmitted from the driving shaft SF3 to the driven shaft SF4, and the degree of screwing between the male and female screws changes. It changes the length L of the stay 260, so that the angle of view of the subject OB in the document image capturing mode can be optionally adjusted.

By driving the stay driving mechanism 207 and the stay extending/contracting mechanism 208, as will be described later, the digital camera 10 can move in parallel in the horizontal direction while making the distance to the subject OB constant.

Subsequently, the pedestal 270 will be described. The pedestal 270 is provided with the interface 203. The interface 203 includes a display interface and can output generated image data to the display 30 such as a projector electrically connected.

The pedestal 270 has an original brightness detector 206. The original brightness detector 206 is constituted by an optical sensor such as a phototransistor. The original brightness detector 206 has the function of detecting light from the subject placing space P and outputting a signal according to the brightness of the detected light. The original brightness detector 206 functions for detecting whether the subject OB is placed on the subject placing space P or not. Concretely, brightness information of the subject placing space P before the subject OB is placed is stored as initial data. By a change from brightness information of the case where the subject OB is placed, whether the subject OB is placed or not is detected. In the case where brightness of the subject placing space P and that of the subject OB are close to each other, it is preferable to use a table dedicated to the subject OB (original table), set the subject OB on the table, and detect the presence or absence of the subject OB.

The pedestal 270 also has the operation part 204. The operation part 204 has a group of a plurality of buttons, to be concrete, buttons (operation members) more than the operation part 111 of the digital camera 10. When the digital camera 10 and the supporting stage 20 are coupled to each other, the buttons have functions equivalent to those of the operation part 111 provided in the digital camera 10. Consequently, when coupled, all of operations such as image capturing and setting operations in the digital camera 10 can be performed by operating the operation part 204 of the pedestal 270 without touching the digital camera 10.

Next, the functional configuration of the supporting stand 20 will be described. FIG. 9 is a block diagram showing the functional configuration of the supporting stand 20. As shown in FIG. 9, the supporting stand 20 has the overall controller 220 for controlling the operations of the components of the supporting stand 20 in a centralized manner. The overall controller 220 is a microcomputer having a RAM 230 and a ROM 240. By carrying out a program 241 stored in the ROM 240 by the microcomputer, the overall controller 220 controls the components of the supporting stage 20 in a centralized manner. The ROM 240 is a nonvolatile memory which cannot electrically rewrite data.

When the digital camera 10 and the supporting stage 20 are coupled to each other, the coupling detector 201 outputs a signal indicative of the coupling to the overall controller 220 and the coupling detector 114 of the digital camera 10. For example, it is set so that the potential is at the GND level at the time of non-coupling and is changed to the power source voltage level at the time of coupling.

The data transmission/reception part 202 is provided to transmit/receive a control signal and image data in a predetermined communication method between the overall controller 120 of the digital camera 10 and the overall controller 220 of the supporting stage 20 when the digital camera 10 and the supporting stage 20 are coupled to each other. Image data captured by the digital camera 10 can be outputted to the display 30 such as a projector via the overall controller 220 and the interface 203 of the supporting stage 20, which will be described later. The digital camera 10 can be also operated by the operation part 204 provided in the supporting stage 20.

The supporting stage 20 is provided with the operation part 204. Data of an operation performed is inputted to the overall controller 220 and is affected in an operation state of the supporting stage 20. The operation of the operation part 204 can be transferred to the overall controller 220 and also to the overall controller 120 of the digital camera 10 via the data transmission/reception part 202. As described above, by the operation of the operation part 204, image capturing of the digital camera 10 and setting operations can be also performed.

The original brightness detector 206 detects light from the subject placing space P and outputs a signal according to the brightness to the overall controller 220. In the case where the digital camera 10 and the supporting stage 20 are coupled to each other, not only the supporting stage 20 but also the digital camera 10 can obtain brightness information of the subject OB placed on the subject placing space P.

The stay driving mechanism 207 and the stay extending/contracting mechanism 208 are driven on the basis of control signals outputted from the overall controller 220. The control signals are outputted when the user performs a predetermined operation on the operation part 204 or an instruction is given from the digital camera 10.

Results of detection of the stay angle sensor 210 and the stay length sensor 211 are outputted to the overall controller 220 and held in the image capturing parameter storage part 131 provided in the RAM 130.

A battery 213 supplies power to each of the components of the supporting stage 20.

The process of removing reflection using the image capturing system 1 having the above-described configuration will be described below.

Process of Removing Reflection

First, the principle of removing reflection will be described.

FIG. 10 illustrates the principle of removing reflection.

A lighting device LT is, for example, a fluorescent lamp or the like, is fixed in a space as a light source in a room, and cannot be easily moved. On the other hand, the subject OB is, for example, a paper original and has a plane or a gentle curved surface. Consequently, light from the lighting device LT is reflected by the surface of the subject OB and tends to enter the digital camera 10. For example, when the digital camera 10 exists in a position P1, light from the lighting device LT is normally reflected on the subject OB and is incident on the digital camera 10, so that reflection occurs in an area Q1 of the subject OB.

The image capturing system 1 has a configuration in that by the driving of the stay driving mechanism 207 and the stay extending/contracting mechanism 208, the distance (height) from the subject OB is made constant, and the digital camera 10 can be moved in parallel in the horizontal direction. With the configuration, while changing the relative positions of the subject OB and the digital camera 10, first and second images can be obtained by the CCD 103.

In the image capturing system 1, by the driving of the stay driving mechanism 207 and the stay extending/contracting mechanism 208, the digital camera 10 is moved in parallel by a distance MV from a position P1 in the direction of the arrow. By the movement, the digital camera 10 reaches a position P2. In the position P2, the relative positions of the subject OB and the digital camera 10 change and the optical path of reflection light changes, so that reflection of light from the lighting device LT is incident in an area Q2, not the area Q1, of the subject OB.

Therefore, by capturing an image of the subject OB twice by the digital camera 10 positioned in the position P1 and the position P2, an image including reflection in the area Q1 of the subject OB is obtained from the position P1, and an image including reflection in the area Q2 is obtained from the position P2. In this case, in the image captured from the position P2, reflection does not occur in the area Q1 of the subject OB. Consequently, the image of the area Q1 is extracted. The image in the area Q1 of the captured image from the position P1 is replaced with the extracted image portion, thereby enabling an image which is not influenced by reflection light from the lighting device LT to be generated.

In the following, a process of preventing reflection will be described by taking a concrete example.

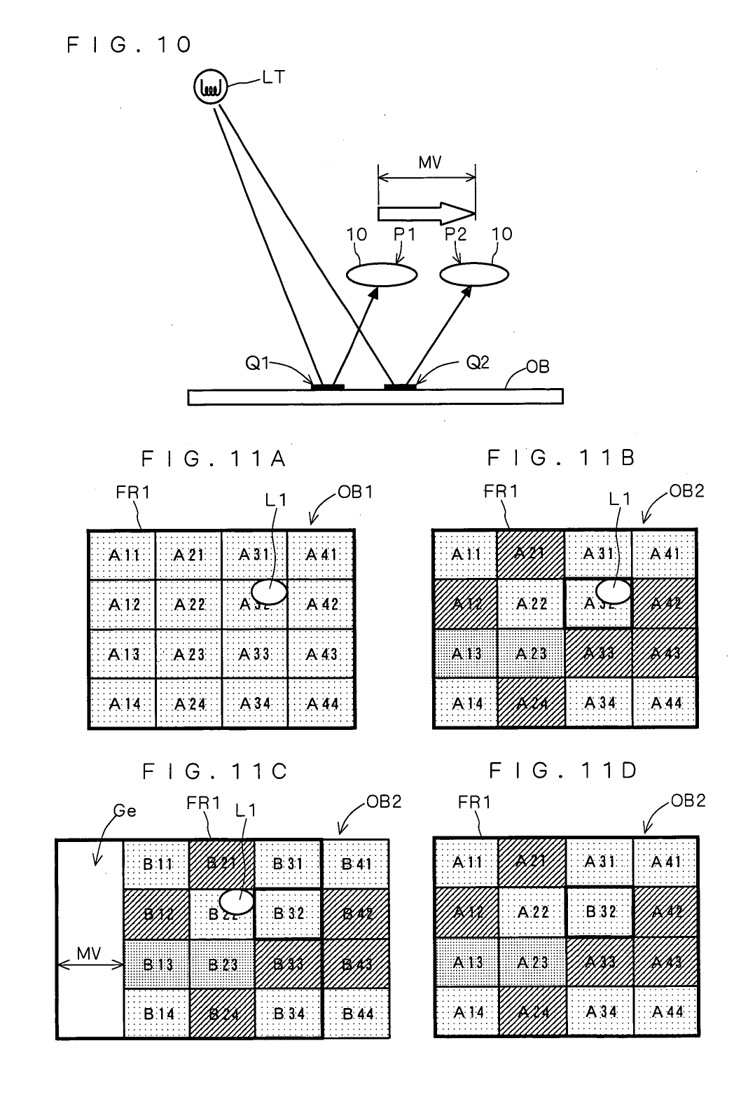

FIGS. 11A to 11D illustrate the process of preventing reflection. Each of FIGS. 11A to 11D shows the relation between a subject and an image capturing range FR1. Herein, the angle of view is adjusted so that the subject is photographed in the full image capturing range FR1. The captured image (subject) is divided into 16 areas A11 to A44 (or B11 to B44).

First, an image of a subject OB1 made of a material in which reflection occurs easily is captured in pre-photographing and an area where reflection L1 occurs is detected in advance. For example, in FIG. 11A, the reflection L1 occurs in the area A32.

In order to determine whether reflection of light from the lighting device occurs in the image capturing range FR1 or not, a matrix having 16 elements a11 to a44 corresponding to brightness in the areas A11 to A44 is defined as the following expression 1.

$$( \begin{matrix}a11 & a21 & a31 & a41 \\ a12 & a22 & a32 & a42 \\ a13 & a23 & a33 & a43 \\ a14 & a24 & a34 & a44\end{matrix} ) \qquad Expression 1$$

The brightness of each of the elements all to a44 is measured in the brightness distribution matrix shown in Expression 1. It is determined that reflection occurs in an area of which measured brightness is equal to or more than threshold Bt. Concretely, the presence or absence of reflection is determined by performing computation as shown by Expression 2.

$$( \begin{matrix}INT ( a11 / Bt ) & INT ( a21 / Bt ) & INT ( a31 / Bt ) & INT ( a41 / Bt ) \\ INT ( a12 / Bt ) & INT ( a22 / Bt ) & INT ( a32 / Bt ) & INT ( a42 / Bt ) \\ INT ( a13 / Bt ) & INT ( a23 / Bt ) & INT ( a33 / Bt ) & INT ( a43 / Bt ) \\ INT ( a14 / Bt ) & INT ( a24 / Bt ) & INT ( a34 / Bt ) & INT ( a44 / Bt )\end{matrix} ) = ( \begin{matrix}0 & 0 & 0 & 0 \\ 0 & 0 & N & 0 \\ 0 & 0 & 0 & 0 \\ 0 & 0 & 0 & 0\end{matrix} ) \qquad Expression 2$$

Specifically, each of the elements a11 to a44 shown in Expression 1 is divided by the brightness threshold Bt and the decimal portion is dropped. By the computation, the area A32 (FIG. 11A) corresponding to the element expressed by an integer N (N: an integer of 1 or more) is detected as an area where the reflection L1 occurs in an area unit obtained by dividing the image (reflection area), as an image area having the brightness equal to or more than the threshold Bt.

After detecting the area A32 of the image in which reflection occurs by pre-photographing, a subject OB2 of which image is desired to be captured is placed and image capturing is performed without moving the position of the digital camera 10. Consequently, the reflection L1 occurs in the area A32 detected in advance (FIG. 11B).

Since the area A32 influenced by the reflection L1 is only one section, the digital camera 10 is moved from the position P1 to the position P2 so as to move a reflection area in the image capturing range FR1 only by one section (width of the area) (see FIG. 10).

Since the position of the image capturing range FR1 is shifted relative to the subject OB2 by the movement of the digital camera 10, the reflection L1 shifts from the area A32 on the subject OB2 shown in FIG. 11B to an area B22 on the subject OB2 shown in FIG. 11C. In this case, an image of the subject OB2 is captured in the full image capturing range FR1 as shown in FIG. 11B, so that a right end portion of the subject OB2 lies out of the image capturing range FR1 by the movement amount MV (FIG. 10) of the digital camera 10 as shown in FIG. 11C. However, since the movement direction and the movement amount MV of the digital camera 10 are already known, it is easy to obtain the corresponding relation between each of the areas shown in FIG. 11B and each of the areas shown in FIG. 11C. In an area B32 corresponding to the area A32 on the subject OB2 (FIG. 11B) in which the reflection L1 occurs, reflection of light from the lighting device does not occur as shown in FIG. 11C.

An image portion of the area B32 is extracted from the image of the image capturing range FR1 shown in FIG. 11C and replaces the image portion of the area A32 in which the reflection L1 occurs in the image of the image capturing range FR1 shown in FIG. 11B. That is, the image portion to be replaced is replaced area by area (area unit) obtained by dividing the base image (first image).

As a result, an image from which the reflection area is removed can be generated as shown in FIG. 11D.

Although the case where reflection occurs in only one divided area has been described above, a case where reflection occurs in a plurality of divided areas will be described later.

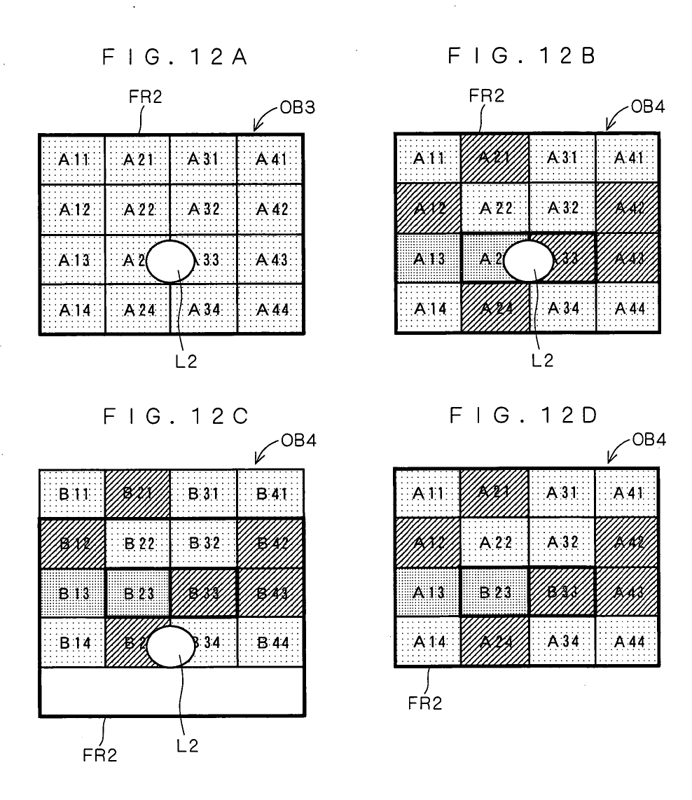

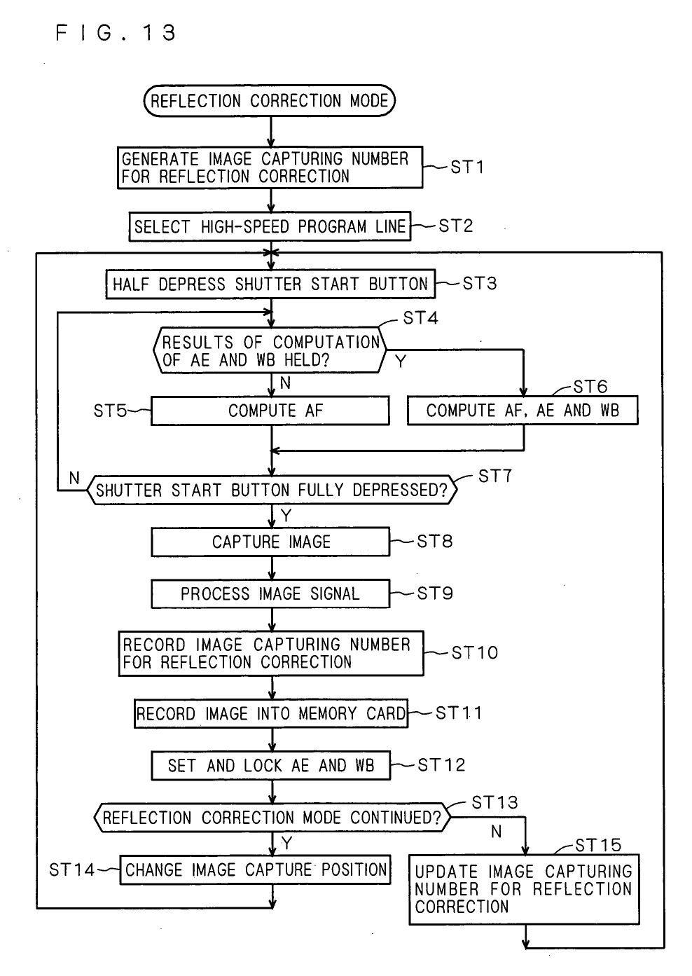

FIGS. 12A to 12D illustrate the process of preventing reflection. Each of FIGS. 12A to 12D shows the relation between the subject and an image capturing range FR2. Herein, the angle of view is adjusted so that the subject is captured in the full image capturing range FR2. The captured image (subject) is divided into 16 areas A11 to A44 (or B11 to B44).

In a manner similar to the process of preventing reflection, for example, an image of a subject OB3 made of a material in which reflection occurs easily is captured in advance, and an area where reflection L2 occurs is detected in advance. For example, the reflection L2 occurs in the areas A23 and A33 as shown in FIG. 12A.

In order to determine whether reflection of light from the lighting device occurs in the image capturing range FR2 or not, a matrix having 16 elements c11 to c44 corresponding to brightness of the areas A11 to A44 is defined by the following expression 3.

$$( \begin{matrix}c11 & c21 & c31 & c41 \\ c12 & c22 & c32 & c42 \\ c13 & c23 & c33 & c43 \\ c14 & c24 & c34 & c44\end{matrix} ) \qquad Expression 3$$

The brightness of each of the elements c11 to c44 in the brightness distribution matrix shown by Expression 3 is measured. It is determined that reflection occurs in an area of which measured brightness is equal to or more than the threshold Bt. Concretely, by performing the computation as shown by the following expression 4, the occurrence of reflection is determined.

$$( \begin{matrix}INT ( c11 / Bt ) & INT ( c21 / Bt ) & INT ( c31 / Bt ) & INT ( c41 / Bt ) \\ INT ( c12 / Bt ) & INT ( c22 / Bt ) & INT ( c32 / Bt ) & INT ( c42 / Bt ) \\ INT ( c13 / Bt ) & INT ( c23 / Bt ) & INT ( c33 / Bt ) & INT ( c43 / Bt ) \\ INT ( c14 / Bt ) & INT ( c24 / Bt ) & INT ( c34 / Bt ) & INT ( c44 / Bt )\end{matrix} ) = ( \begin{matrix}0 & 0 & 0 & 0 \\ 0 & 0 & 0 & 0 \\ 0 & X & Y & 0 \\ 0 & 0 & 0 & 0\end{matrix} ) \qquad Expression 4$$

Specifically, each of the elements a11 to a44 shown in Expression 3 is divided by the brightness threshold Bt and the decimal portion is dropped. As a result, the areas A23 and A33 (FIG. 12A) corresponding to the elements expressed by integers X and Y (each of X and Y: an integer of 1 or more) are detected as image areas each having the threshold Bt or more, that is, the areas where the reflection L2 occurs (reflection area).

After detecting the areas in the image in which the reflection L2 occurs by pre-photographing as described above, a subject OB4 of which image is desired to be captured is placed and image capturing is performed without moving the position of the digital camera 10. Consequently, the reflection L2 occurs in the two areas A23 and A33 detected in advance (FIG. 12B).

Since the two areas A23 and A33 influenced by the reflection L2 are neighboring areas, the digital camera 10 is moved downward in the drawing only by an amount of one section so that reflection does not occur in areas corresponding to the areas A23 and A33. The reason why the digital camera 10 is moved downward in the drawing is that in the case where reflection occurs in a plurality of areas, the movement amount is smaller by shifting the digital camera 10 in the short-side direction for all of the areas where reflection occurs, and it is more efficient.

Since the position of the image capturing range FR2 for the subject OB4 is shifted by the movement of the digital camera 10, the reflection L2 shifts from the two areas A23 and A33 on the subject OB4 shown in FIG. 12B to two areas B24 and B34 on the subject OB4 shown in FIG. 12C. In this case, since an image of the subject OB4 is captured in the full image capturing range FR2 as shown in FIG. 12B, a lower end portion of the subject OB4 lies out of the image capturing range FR2 as shown in FIG. 12C. However, the movement direction and the movement amount of the digital camera 10 are already known, it is easy to obtain the corresponding relation between each of the areas shown in FIG. 12B and each of the areas shown in FIG. 12C. In the two areas B23 and B33 corresponding to the two areas A23 and A33 (FIG. 12B) on the subject OB4 in which the reflection L2 occurs, reflection of light from the lighting device does not occur as shown in FIG. 12C.

An image portion of the areas B23 and B33 is extracted from the image of the image capturing range FR2 shown in FIG. 12C and replaces the image portion of the areas A23 and A33 in which the reflection L2 occurs in the image of the image capturing range FR2 shown in FIG. 12B.

By the operation, an image from which the reflection area is removed as shown in FIG. 12D can be generated.

As described above, in the case where the digital camera 10 is moved in parallel with the surface (image capturing surface) of a subject, the angle of view hardly changes. Therefore, only by extracting a divided area where no reflection occurs and performing synthesis of replacing the area where the reflection occurs with the image portion of the extracted area, the reflection can be easily promptly removed. In particular, in the case of the image capturing system 1 of the first preferred embodiment, since the digital camera 10 is held by the supporting stand 20, it is easy to remove the reflection. Specifically, in the case of capturing images of the same subject while changing the relative position between the digital camera 10 and the subject OB and partially overlapping the captured images, parallel movement in which the distance between the digital camera 10 and the object is unchanged can be performed by the supporting stand 20 with good precision. Thus, captured images can be easily correlated with each other and imaging process can be performed easily.

Operation of Image Capturing System 1

Basic operation in the image capturing system 1 will now be described. In the following, operation in a reflection correction mode and operation of a reflection correcting process will be described separately.

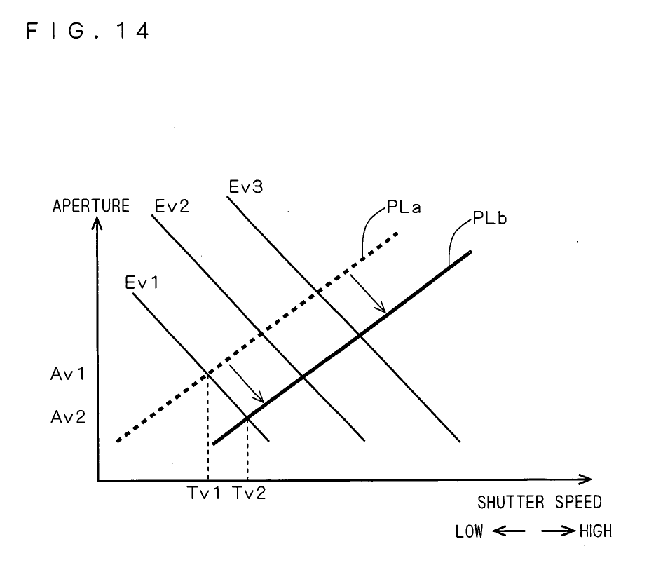

FIG. 13 is a flowchart showing the operation of the reflection correction mode. The operation is carried out by the overall controller 120 of the digital camera 10.

First, when the reflection correction mode is set by depression of the menu button 156, an image capturing number for reflection correction is generated (step ST1). The image capturing number for reflection correction indicates a group of images used for correcting reflection and will be described in detail below.

Generally, associated information peculiar to the digital camera 10 is stored in a private tag dedicated to Exif in image data. However, in the private tag, the image capturing number for reflection correction is recorded. The image capturing number for reflection correction is generated so as not to be overlapped when it is newly generated. The image capturing number for reflection correction is generated by, for example, combining a numerical value which is counted up and a character train indicative of year/month/date and time measured by a built-in clock provided in the digital camera 10. Concretely, when image capturing time is 10:15 on Sep. 15, 2003, a three-digit number 000 to 999 which is counted up as a different number is added to a numerical value train “200309151015” in the case where image groups regarding the reflection correction are different from each other.

In step ST2, a high-speed program line is selected. To be concrete, in the case where the digital camera shifts to the reflection correction mode in a state where a program line PLa shown in FIG. 14 is set, a program line PLb using faster shutter speed than the program line PLa is set. The reason why a higher-speed program line is selected is to prevent a camera shake at the time of capturing an image of a subject.

It is determined that whether or not the shutter start button 153 is half-depressed by the user (S1 ON) (step ST3) and results of computation of AE and WB are held. Specifically, when the shutter start button 153 is half-depressed, image capturing conditions of AF, AE and WB are computed and results of the computation are stored in the image capturing parameter storage part 131. It is determined that whether the results of computation of AE and WB are held in the image capturing parameter storage part 131 or not. In the case where the results of computation of AE and WB are held, the program advances to step ST5. In the case of NO in step ST4, the program advances to step ST6.

In step ST5, image capturing parameters regarding AF are computed and a result of the computation is stored in the image capturing parameter storage part 131.

In step ST6, image capturing parameters regarding AF, AE and WB are computed and results of the computation are stored in the image capturing parameter storage part 131.

In step ST7, it is determined that whether the shutter start button 153 is fully-depressed by the user (S2 ON) or not. In the case where the shutter start button 153 is fully-depressed, the program advances to step ST8. In the case of NO in step ST7, the program returns to step ST4.

In step ST8, an image of the subject OB is captured. An image signal of the subject OB is thereby obtained by the CCD 103.

In step ST9, the image signal obtained in step ST8 is processed by the signal processor 104, A/D converter 105 and image processor 106, thereby generating digital image data.

In step ST10, the image capturing number for reflection correction is recorded in the private tag of the image data processed in step ST9. Herein, in the private tag of each of image data in the same group captured by a plurality of image capturing operations in the reflection correction mode, without changing the image capturing number for reflection correction, the same character train (numerical value train) such as “200309151016001” is recorded.

In step ST11, image data is recorded in the memory card 113.

In step ST12, results of computation of AE and WB are set and locked. Specifically, although the results of computation of AF, AE and WB are stored in the image capturing parameter storage part 131, only the result of computation of AF is reset, and results of computation of AE and WB are held. Further, until the reflection correction mode is finished, a change in the picture quality and the image size is inhibited.

In step ST13, it is determined that whether the reflection correction mode is continued or not. Concretely, it is determined that whether or not the menu button 156 is depressed to set finishing of the reflection correction mode. In the case of continuing the reflection correction mode, the program advances to step ST14. In the case of NO in step ST13, the program returns to step ST3.

In step ST14, the image capturing position of the digital camera 10 is changed. By driving the stay driving mechanism 207 and the stay extending/contracting mechanism 208, as shown in FIG. 10, the position of the digital camera 10 is changed so as to move in parallel to the image capturing surface of the subject OB.

In step ST15, the image capturing number for reflection correction is updated. Specifically, in the case of performing image capturing a plurality of times in the reflection correction mode at 10:15 on Sep. 15, 2003 (for example, “200309151015001” is recorded in the private tag of a captured image) and, after that, capturing an image of another subject at 10:16, for example, the number is updated to “200309151016001” different from the above-described image capturing number for reflection correction.

The reflection correcting process will now be described.

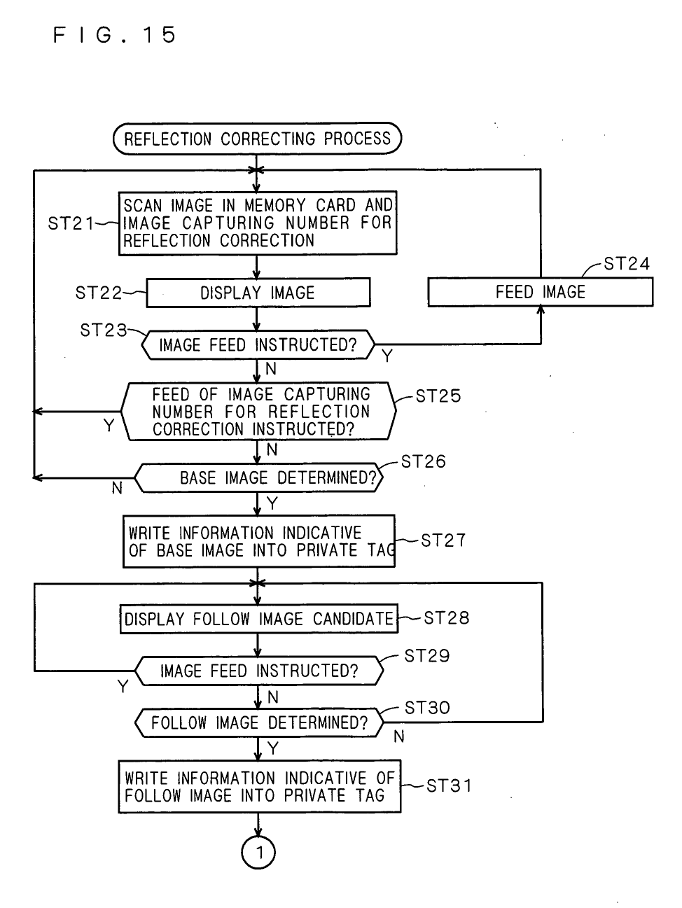

FIGS. 15 and 16 show a flowchart of the operations of the reflection correcting process. The operation is carried out by the overall controller 120 of the digital camera 10.

First, when the mode switching lever 159 is operated to set a reproduction mode and, after that, “reflection correcting process” is selected in a menu screen, an image recorded in the memory card 113 and the image capturing number for reflection correction recorded in the private tag are scanned (step ST21).

In step ST22, on the basis of the result of scan in step ST11, one of a plurality of images having the same image capturing number for reflection correction is displayed on the liquid crystal monitor 112.

In step ST23, it is determined that whether image feed is instructed or not. Concretely, it is determined that whether the cross cursor buttons 158R and 158L for instructing feed of images having the same image capturing number for reflection correction are operated by the user or not. In the case where the image feed is instructed, the program advances to step ST24. In the case of NO in step ST23, the program advances to step ST25.

In step ST24, frame feed is performed among the images having the same image capturing number for reflection correction.

In step ST25, it is determined that whether feed of the image capturing number for reflection correction is instructed or not. Concretely, it is determined that whether the cross cursor buttons 158U and 158D for instructing a change in the image capturing number for reflection correction are operated by the user or not. In the case where the image capturing number for reflection correction is fed, the program returns to step ST21. In the case of NO in step ST25, the program advances to step ST26.

In step ST26, it is determined that whether a base image is determined or not. The base image is, as shown in FIG. 11B, a base image subjected to the reflection correction (FIG. 11D), that is, an image most of which is used except for the area A32 including the reflection L1. It is determined that whether the base image is designated by depression of the execution button 157 or not. In the case where the base image is determined, the LED 162 indicative of the base image selection state is turned off, the LED 163 indicative of a follow image selection state is turned on, and the program advances to step ST27. In the case of NO in step ST26, the LED 163 indicative of the base image selection state is continuously turned on, and the program returns to step ST21.

In step ST27, information indicative of the base image is written in the private tag of an image determined by the operation of the execution button 157.

In step ST28, a follow image candidate is displayed on the liquid crystal monitor 112. The follow image is, as shown in FIG. 11C, an image having an image portion which replaces a part of the image subjected to the reflection correction (FIG. 11D), that is, an image as a material for reflection correction for the base image.

In step ST29, in a manner similar to step ST25, it is determined that whether the image feed among images having the same image capturing number for reflection correction is instructed or not. In the case where the image feed is instructed, the program returns to step ST28. In the case of NO in step ST29, the program advances to step ST30.

In step ST30, it is determined that whether the follow image is determined or not. Concretely, it is determined that whether or not the execution button 157 is depressed by the user to designate a follow image. In the case where a follow image is determined, the program advances to step ST31. In the case of NO in step ST30, the program returns to step ST28.

In step ST31, information indicative of a follow image is written in the private tag of an image determined by the operation of the execution button 157.

In step ST32, brightness distribution matrixes of the base image and the follow image are generated. Concretely, each of the base image and the follow image is divided into a plurality of areas as shown in FIG. 11 and a matrix having, as elements, average brightness values of areas as expressed by Expression 1 is generated.

In step ST33, a reflection area is specified. Concretely, as shown in Expression 2, an area having average brightness higher than the brightness threshold Bt in an image is obtained, thereby determining an area where reflection occurs. That is, the reflection area in the base image (first image) is detected. The reflection area is set as an image portion to be replaced.

In step ST34, a relative position is calculated by using the subject as a reference. Concretely, in the reflection correction mode, the image capturing position is changed by the driving of the stay driving mechanism 207 and the stay extending/contracting mechanism 208 in step ST14 in FIG. 13. On the basis of the result of detection of the stay angle sensor 210 and the stay length sensor 211, the relative position between the base image and the follow image is obtained. In other words, information of a positional deviation between the position of the subject in the base image (first image) and the position of the subject in the follow image (second image) is obtained.

In step ST35, image data of a divided area corresponding to the reflection area in the base image is extracted from the follow image. Concretely, for example, the area B32 (FIG. 11C) corresponding to the reflection area A32 in the base image shown in FIG. 11B is extracted. In other words, a replacing image portion which corresponds to the site of the subject appearing in an image portion to be replaced in the base image (first image) in the follow image (second image) and is not detected as the reflection area is extracted.

In step ST36, a process of replacing the reflection area in the base image with the image data of the divided area extracted in step ST37 is performed. Specifically, the image portion to be replaced in the base image (first image) is replaced on the basis of the replacing image portion (divided area) extracted in step ST37.

In step ST37, the base image subjected to the replacing process in step ST38 is generated as a reflection corrected image, and information indicating that the image is subjected to the reflection correction is written in the private tag of the reflection corrected image.

In step ST38, the reflection corrected image is displayed on the liquid crystal monitor 112.

In step T39, it is determined that whether the reflection corrected image is stored or not. To be specific, it is determined that whether or not the user visually recognizes the reflection corrected image displayed in step ST38 and performs an operation of recording the image. In the case of storing the reflection corrected image, the program advances to step ST40. In the case of NO in step ST39, the process is finished.

In step ST40, the reflection corrected image is recorded in the memory card.

By the operation of the image capturing system 1, the reflection area in the base image is replaced with the area extracted from the follow image obtained by changing the image capture position, so that reflection on the subject can be easily promptly removed.

### Second Preferred Embodiment

In a second preferred embodiment of the present invention, in a manner similar to the first preferred embodiment, a plurality of images captured by the digital camera 10 are synthesized and reflection is removed. The second preferred embodiment is different from the first preferred embodiment with respect to the point that images are captured only by the digital camera 10 without using the supporting stand 20 as an auxiliary mechanism for supporting the digital camera 10. Consequently, in a plurality of image capturing operations, it is difficult to grasp a relative movement amount between the digital camera 10 and the subject.

In the second preferred embodiment, the user performs image capturing a plurality of times while moving the gripped digital camera 10 in parallel without an angle so that the relative positions between the base image using a subject as a reference and the follow image can be easily grasped. By the operation, while changing the relative positions between the subject OB and the digital camera 10, the base image (first image) and the follow image (second image) can be obtained by the CCD 103. However, since the image capturing position is not changed mechanically by the supporting stand 20, to calculate the relative positions between the base image and the follow image, pattern matching between the images is necessary.

Therefore, in a program portion PGb (FIG. 4) of the digital camera 10 of the second preferred embodiment, a program for performing pattern matching is added to the programs of the first preferred embodiment.

In the following, the image capturing operation of the second preferred embodiment will be described by taking, as a concrete example, a case where the user grips the digital camera 10 and captures an image of a white board as a subject.

Process of Removing Reflection

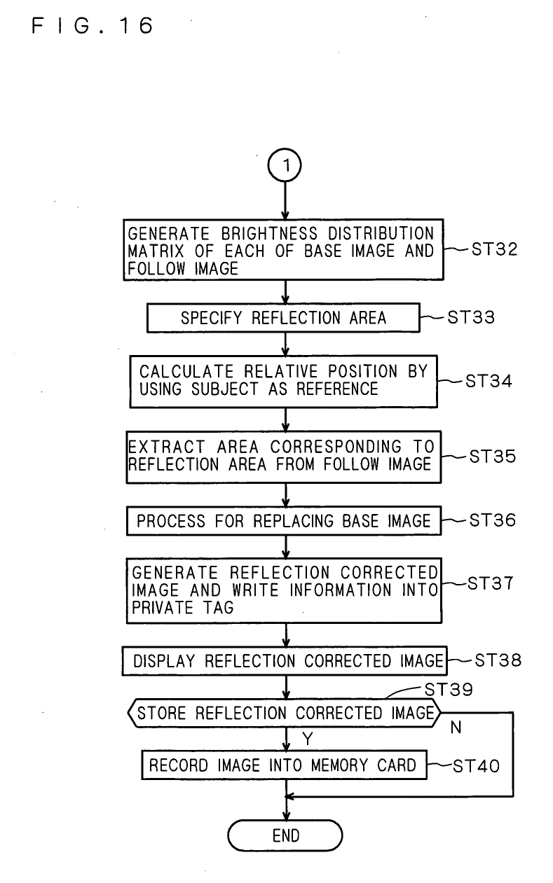

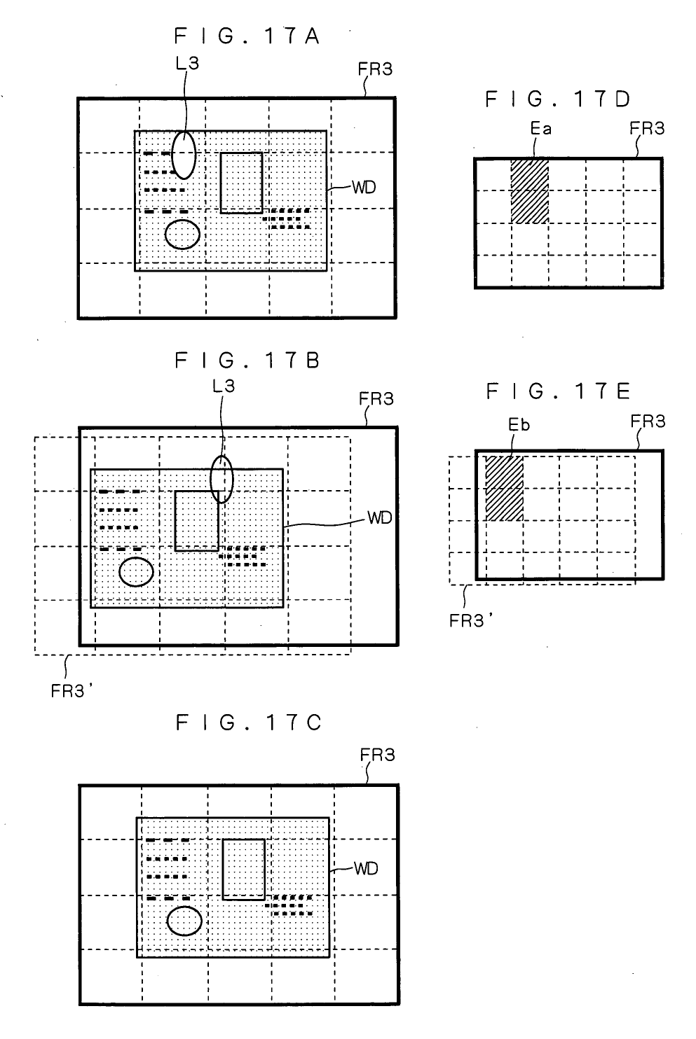

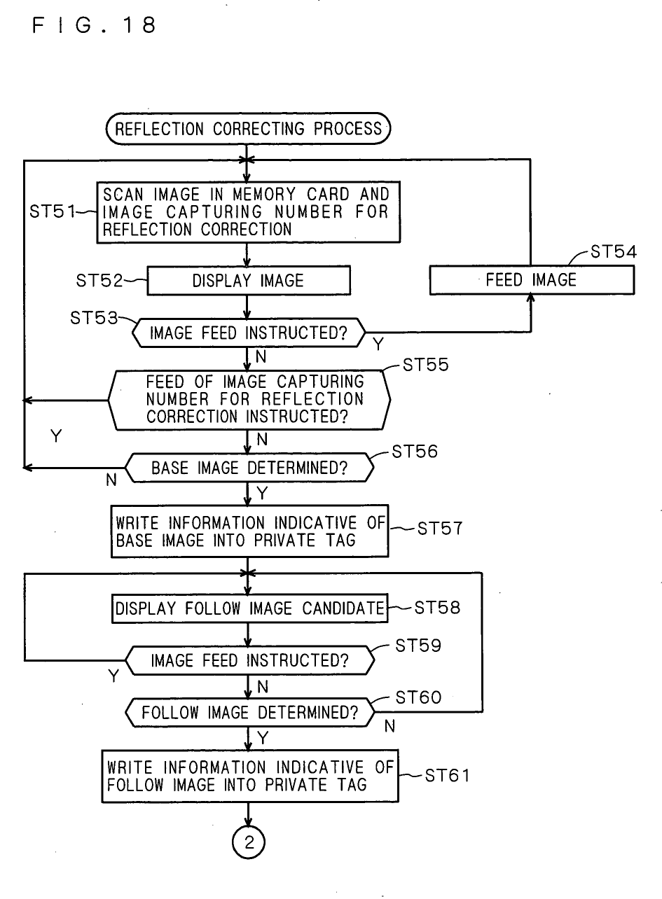

FIGS. 17A to 17E illustrate the process of removing reflection. Each of FIGS. 17A to 17C shows the relation between the subject and the image capturing range. FIGS. 17D and 17E are diagrams showing the simplified relations between the subject and the image capturing range shown in FIGS. 17A and 17B, respectively.

A base image is captured so that, as shown in FIG. 17A, a white board WD as a subject is captured so as to be within an image capturing range FR3. In the captured image, reflection L3 of light from a lighting device occurs on the white board WD. The base image is also divided into a plurality of areas, concretely, 20 areas in a manner similar to the first preferred embodiment.

After that, from the base image captured position, the digital camera 10 is moved in almost parallel to the surface (image capturing surface) of the white board WD to capture a follow image as shown in FIG. 17B. Since the relative positions of the white board WD and the digital camera 10 are changed from the base image, the position of the white board WD is moved to the left in the follow image and the reflection L3 is also slightly moved with respect to the image capturing range FR3.

By performing pattern matching between the base image and the follow image by using the subject as a reference, the relative positions are calculated (which will be described in detail later). By the operation, as shown in FIG. 17B, a base image capturing range FR3′ (broken line frame) can be grasped.

Finally, an area Ea (hatched area in FIG. 17D) in which the reflection L3 occurs in the base image is replaced with an area Eb (hatched area in FIG. 17E) in the follow image, which corresponds to the reflection area Ea. In such a manner, as shown in FIG. 17C, a reflection corrected image from which the reflection L3 is removed can be generated.

In the following, calculation of the relative positions of the base image and the follow image will be described.

First, like the brightness matrix of Expression 1, a matrix Bwb1 having elements each corresponding to average brightness of each of areas obtained by dividing a base image is defined as the following Expression 5. Preferably, the base image is divided into areas of the number larger than that of areas divided in the reflection correcting process (see FIG. 17D). More preferably, the base image is divided into areas of the number as large as possible.

$$Bwb1 = ( \begin{matrix}p11 & p21 & … \\ p12 & p22 & … \\ & … & … \\ p1 ( s - 1 ) & p2 ( s - 1 ) & … \\ & {…}^{ {}^{}} & ⋯ \\ p1y & p2y & …\end{matrix} \begin{matrix}\begin{matrix}pm1 & … & pn1 \\ pm2 & … & pn2 \\ & & \\ pm ( s - 1 ) & … & pn ( s - 1 )\end{matrix} \\ \begin{matrix}… & … & … \\ pmy & … & pny\end{matrix}\end{matrix} \begin{matrix}… & px1 \\ … & px2 \\ & \\ … & pxs \\ & \\ … & pxy\end{matrix} ) \qquad Expression 5$$

A range surrounded by a broken line in the matrix of Expression 5 is an area in which reflection occurs, that is, an area where brightness is higher than a predetermined brightness threshold. By extracting the area, a matrix Cwb1 of the following Expression 6 is obtained.

$$Cwb1 = ( \begin{matrix}pm1 & … & pn1 \\ & … & \\ pm ( s - 1 ) & … & pn ( s - 1 )\end{matrix} ) \qquad Expression 6$$

By substituting the matrix Cwb1 for the matrix Bwb1 of Expression 5, the following matrix of Expression 7 is generated.

$$Bwb1 = ( \begin{matrix}p11 & p21 & ⋯ & p ( m - 1 ) 1 & & & & p ( n + 1 ) 1 & & … & px1 \\ p12 & p22 & … & p ( m - 1 ) 2 & & Cwb1 & & p ( n + 1 ) 2 & & … & px2 \\ & … & & & & & & & & … & \\ p1s & p2s & … & p ( m - 1 ) s & … & … & … & p ( n + 1 ) s & & … & pxs \\ & … & & & & & & & & … & \\ p1y & p2y & & … & pmy & … & pny & & & … & pxy\end{matrix} ) \qquad Expression 7$$

On the follow image as well, a process similar to that of the base image is performed. Specifically, a brightness matrix Bwb2 of the following expression 8 is defined, and a brightness matrix Cwb2 (see Expression 9) corresponding to a reflection area is extracted and substituted for the matrix of Expression 8, thereby generating a matrix of Expression 10.

$$\begin{matrix}Bwb2 = ( \begin{matrix}p11 & p21 & … \\ p12 & p22 & … \\ & … & … \\ p1 ( t - 1 ) & p2 ( t - 1 ) & … \\ & … & ⋯ \\ p1y & p2y & …\end{matrix} \begin{matrix}\begin{matrix}pi1 & … & pj1 \\ pi2 & … & pj2 \\ & & \\ pi ( t - 1 ) & … & pj ( t - 1 )\end{matrix} \\ \begin{matrix}… & … & … \\ pmy & … & pny\end{matrix}\end{matrix} \begin{matrix}… & px1 \\ … & px2 \\ & \\ … & pxt \\ & \\ … & pxy\end{matrix} ) & Expression 8 \\ Cwb2 = ( \begin{matrix}pi1 & … & pj1 \\ & … & \\ pi ( t - 1 ) & … & pj ( t - 1 )\end{matrix} ) & Expression 9 \\ Bwb1 = ( \begin{matrix}p11 & p21 & ⋯ & p ( m - 1 ) 1 & & & & p ( n + 1 ) 1 & & … & px1 \\ p12 & p22 & … & p ( m - 1 ) 2 & & Cwb2 & & p ( j + 1 ) 2 & & … & px2 \\ & … & & & & & & & & … & \\ p1t & p2t & … & p ( i - 1 ) t & … & … & … & p ( j + 1 ) t & & … & pxt \\ & … & & & & & & & & … & \\ p1y & p2y & & … & piy & … & pjy & & & … & pxy\end{matrix} ) & Expression 10\end{matrix}$$

By comparing the partial matrixes obtained by eliminating the matrixes Cwb1 and Cwb2 corresponding to the reflection areas on the basis of the matrix Bwb1 of Expression 7 and the matrix Bwb2 of Expression 10 generated as described above and performing pattern matching, that is, searching the corresponding elements between the matrixes, the relative positions between images can be calculated on the basis of the subject as a reference. Specifically, by the pattern matching, information of a positional deviation between a base image and a follow image is obtained on the basis of an image portion obtained by eliminating the reflection area from an image. Thus, an adverse influence on the pattern matching due to the difference between the positions of the reflection areas in the images can be prevented.

The operation of the digital camera 10 regarding the reflection correction (removal) will now be described.

For image capturing in the reflection correction mode by the digital camera 10 of the second preferred embodiment, operations similar to those in the flowchart of FIG. 13 are performed except for the change in the image capture position in step ST14 in FIG. 13. The image capture position is changed not by the stay driving mechanism 207 and the stay extending/contracting mechanism 208 of the supporting stage 20 but by the user himself/herself. Consequently, a process accompanying the pattern matching process to be described later becomes necessary to obtain the relative positions between images.

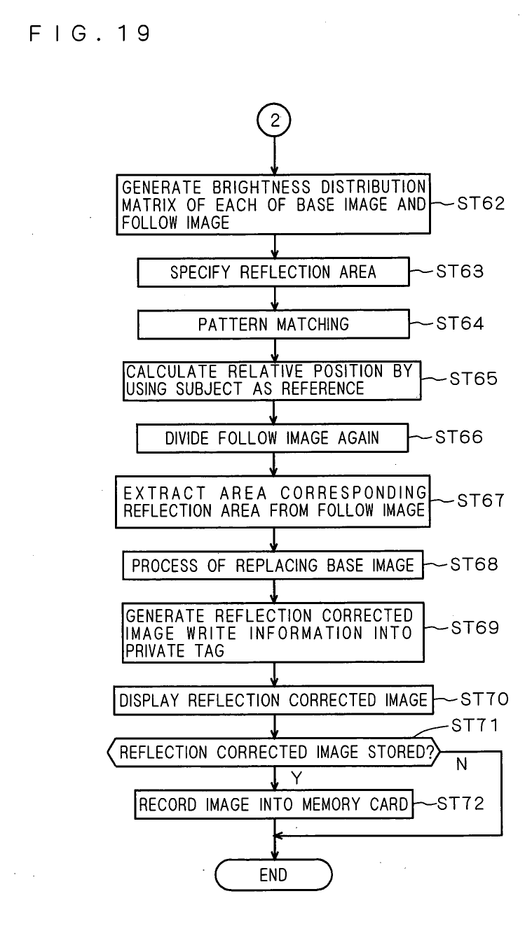

FIGS. 18 and 19 are a flowchart of operations of the reflection correcting process. The operation is carried out by the overall controller 120 of the digital camera 10.

In steps ST51 to ST63, the operations in steps S21 to ST33 in FIGS. 15 and 16 are performed.

In step ST64, on the basis of the base image and the follow image from each of which the reflection area specified in step ST63 is removed, the above-described pattern matching is performed. In the second preferred embodiment, in order to change the image capturing position of the digital camera 10 by the user himself/herself, the relative relations between the base image and the follow image have to be grasped by the pattern matching.

In step ST65, on the basis of a result of the pattern matching in step ST64, relative positions are calculated by using the subject as a reference.

In step ST66, based on the relative position calculated in step ST65, the follow image is divided again. To be specific, since the base image and the follow image are separately captured while changing the image capturing position, a deviation occurs in the position of the subject in the images. After adjusting the relative positions, the images have to be synthesized. Consequently, first, each of the base image and the follow image is divided into areas separately and, after that, pattern matching is carried out to obtain the relative position relation between the images. After that, the follow image is newly divided into areas (division in an image capturing range FR3′ in FIG. 17E) so that areas in the images match each other.

In steps ST67 to ST72, the operations in steps ST35 to ST40 in FIG. 16 are performed.

By the operation of the digital camera 10, reflection in an image can be easily and promptly removed in a manner similar to the first preferred embodiment.

In the second preferred embodiment, since the image capturing position is changed by the user himself/herself, there is the possibility in that variations occur between images other than the positional deviation which occurs due to different photographing angles with respect to the subject and different angles of view.

For example, in a follow image obtained after capturing a base image, there is a case such that an image of a subject is captured in a trapezoid shape. In this case, trapezoid correction is made. A deforming process such as trapezoid correction is carried out by the overall controller 120. The process will be described in detail below.

Although a captured image is displayed on the liquid crystal monitor 112 of the digital camera 10, when the user judges that the trapezoid correction is necessary, the user operates the menu button 156 and selects the trapezoid correction from a display menu. In the trapezoid correction, two kinds of processes of process 1 for enlarging the upper side of a trapezoid and reducing the lower side and process 2 for reducing the upper side and enlarging the lower side of a trapezoid can be selected by the operation of the cross cursor button 158. Further, a correction amount can be selected from a few levels.

After completion of setting of the parameters regarding the trapezoid correction, the parameters are temporarily stored in the RAM 130 of the overall controller 120 and a correcting process is started by the execution button 157. The corrected image is stored by being overwritten on an image which is not yet subject to the correcting process in the image memory 107 or stored as a new image and then recorded on the memory card 113. After that, by replacing an image portion in the base image, where reflection occurs, with an image portion extracted from the corrected image, the reflection can be removed.

As described above, the image portion to be replaced in the base image is changed so as to be adapted to the replacing image portion in the follow image to thereby generate an adaptive image portion and replace the image portion. Thus, the quality of the image from which the reflection is removed is improved.

Modification

In the operation of recording data into the memory card in each of the foregoing preferred embodiments, it is not essential to record the image after the user checks the reflection corrected image displayed as described in steps ST38 to ST40 in FIG. 16. Alternately, as soon as a reflection corrected image is generated, it may be stored into the memory card. In this case, when the user visually recognizes a reflection corrected image displayed on the liquid crystal monitor and judges that image is unnecessary, the reflection corrected image stored in the memory card is erased. By the operation, the reflection corrected image is recorded on the memory card immediately after generation, so that the reflection corrected image can be prevented from being lost due to erroneous operation of the user.

While the invention has been shown and described in detail, the foregoing description is in all aspects illustrative and not restrictive. It is therefore understood that numerous modifications and variations can be devised without departing from the scope of the invention.

1. A digital camera comprising:
(a) an image capturing part for capturing an image of a subject;
(b) a detector for detecting a reflection area, in which reflection occurs, in said image; and
(c) a processor for performing a predetermined process on a first image and a second image captured by said image capturing part while changing relative positions between said subject and said digital camera, wherein
said predetermined process includes the steps of:
(c-1) setting said reflection area detected by said detector in said first image as an image portion to be replaced;
(c-2) extracting a replacing image portion which corresponds to a site of said subject appearing in said image portion to be replaced and is not detected as said reflection area by said detector in said second image; and
(c-3) replacing said image portion to be replaced in said first image with said replacing image portion extracted in said step (c-2).

2. The digital camera according to claim 1, wherein
said detector divides said image into a plurality of areas and detects said reflection area on a divided area unit basis.

3. The digital camera according to claim 1, wherein
said step (c-3) includes the step of:
dividing said first image into a plurality of areas and replacing said image portion to be replaced on the divided area unit basis.

4. The digital camera according to claim 1, wherein
information of a positional deviation between a position of said subject in said first image and a position of said subject in said second image is obtained.

5. The digital camera according to claim 4, wherein
said information of said positional deviation is obtained on a basis of an image portion obtained by removing said reflection area detected by said detector from said image.

6. The digital camera according to claim 1, wherein
said step (c-3) includes the steps of:
changing said image portion to be replaced so as to be adapted to said replacing image portion, thereby generating an adapted image portion; and
replacing said image portion to be replaced in said first image with said adapted image portion.

7. A digital camera comprising:
(a) a detector for detecting a reflection area, in which reflection occurs, in an image captured by an image capturing part; and
(b) an image processor for generating one image by synthesizing areas other than said reflection area in a plurality of images captured by said image capturing part while changing relative positions between a subject and said digital camera.

8. The digital camera according to claim 7, wherein
said detector divides said image into a plurality of areas and detects said reflection area on the divided area unit basis.

9. The digital camera according to claim 7, wherein
one image out of said plurality of images is divided into a plurality of areas, and synthesis is performed on the divided area unit basis.

10. The digital camera according to claim 7, wherein
information of a positional deviation between a position of said subject in one image and a position of said subject in another image out of said plurality of images is obtained.

11. The digital camera according to claim 10, wherein
said information of said positional deviation is obtained on a basis of an image portion obtained by removing said reflection area detected by said detector from said image.

12. The digital camera according to claim 7, wherein
when a portion of one image and a portion of another image out of said plurality of images are synthesized, one of portions of images is changed so as to be adapted to another of said portions of images and, after that, said portions of images are synthesized.

13. An image generating method comprising the steps of:
(a) capturing a first image and a second image of a subject while changing relative positions between a subject and a digital camera;
(b) detecting a reflection area, in which reflection occurs, in said image captured in said step (a);
(c) carrying out a first specifying process for setting, as an image portion to be replaced, said reflection area detected in said step (b) in said first image;
(d) carrying out a second specifying process of extracting a replacing image portion which corresponds to a site of said subject appearing in said image portion to be replaced and is not detected as said reflection area in said step (b) from said second image; and
(e) replacing said image portion to be replaced in said first image with said replacing image portion extracted in said step (d).

14. The image generating method according to claim 13, wherein
said step (b) includes the step of:
(b-1) dividing said image into a plurality of areas and detecting said reflection area on a divided area unit basis.

15. The image generating method according to claim 13, wherein
said step (e) includes the step of:
(e-1) dividing said first image into a plurality of areas and replacing said image portion to be replaced on a divided area unit basis.

16. The image generating method according to claim 13, further comprising the step of:
(f) obtaining information of a positional deviation between a position of said subject in said first image and a position of said subject in said second image.

17. The image generating method according to claim 16, wherein
said step (f) includes the step of:
(f-1) obtaining said information of said positional deviation on a basis of an image portion obtained by removing said reflection area detected in said step (b) from said image.

18. The image generating method according to claim 13, wherein
said step (e) includes the steps of:
(e-2) changing said replacing image portion so as to be adapted to said image portion to be replaced, thereby generating an adapted image portion; and
(e-3) replacing said image portion to be replaced in said first image with said adapted image portion.
